(19) United States
(12) Patent Application Publication
(10) Pub. No.: US 2013/0219260 A1
(43) Pub. Date: Aug. 22, 2013

(54) INSTRUMENT, INFORMATION PROCESSING SYSTEM, AND INFORMATION PROCESSING METHOD

(71) Applicant: Tomoya HIROKAWA, Kanagawa (JP)

(72) Inventor: Tomoya HIROKAWA, Kanagawa (JP)

(73) Assignee: RICOH COMPANY, LTD., Tokyo (JP)

(21) Appl. No.: 13/764,822

(22) Filed: Feb. 12, 2013

(30) Foreign Application Priority Data
Feb. 17, 2012 (JP) 2012-032623
Oct. 29, 2012 (JP) 2012-237515

(51) Int. Cl. G06F 17/22

(52) U.S. Cl. CPC G06F 17/2247
USPC 715/234

(57) ABSTRACT

Disclosed is an instrument including a display part, a transmission part configured to transmit attribute information of the instrument to an information processing device, a display control part configured to transmit a request for acquisition of a list of identification information of a Web page to the information processing device and display the list sent from the information processing device in response to the request for acquisition on the display part, and an acquisition part configured to acquire a program through a network when identification information of a Web page selected in the list is associated with identification information of the program.

### BACKGROUND OF THE INVENTION

1. Field of the Invention

An aspect of the present invention relates to at least one of an instrument, an information processing system, and an information processing method.

2. Description of the Related Art

Conventionally, an image formation apparatus has been present that has installed browser software for displaying Hyper Text Markup Language (HTML) data acquired through a network or from an inside of an instrument as an operational picture of such an instrument. In such browser software, it may be possible to interpret a script extended for instrument control (which will be referred to as an “extended script” below) so as to execute an instrument control as well as to display a picture. According to browser software capable of interpreting an extended script, it is possible to provide such an extended script as a browser-based Application Program Interface (API) for customization (for example, see Japanese Patent Application Publication No. 2006-352845).

For example, it is possible for a third-party vendor who develops a new application, etc., to generate a World Wide Web (Web) page to be displayed on browser software by utilizing an extended script so that a service capable of utilizing a hardware resource of an image formation apparatus is provided through such a Web page.

It is possible to consider that a set of Web pages as described above are registered in a predetermined portal site so that a portal picture for displaying a list of such Web pages is provided. It is possible for a user to select a Web page from such a portal picture so that a desired web page is readily utilized.

However, performance or capability of one image formation apparatus is not necessarily identical to that of another. Hence, an extended script defined in a Web page to be downloaded through a network is not necessarily feasible for all image formation apparatuses. For example, when a Web page that includes a script indicating a command for executing a scan is downloaded in a printer having no scan function, it is not possible for such a printer to execute processing in accordance with such an extended script.

In recent years, instruments accessible to a Web application have been diversified. Hence, it is considered that a possibility of causing inconsistency between a web page and an instrument as described above is not limited to that of an image formation apparatus but is a common problem in instruments accessible to a Web page.

### SUMMARY OF THE INVENTION

According to one aspect of the present invention, there is provided an instrument including a display part, a transmission part configured to transmit attribute information of the instrument to an information processing device, a display control part configured to transmit a request for acquisition of a list of identification information of a Web page to the information processing device and display the list sent from the information processing device in response to the request for acquisition on the display part, and an acquisition part configured to acquire a program through a network when identification information of a Web page selected in the list is associated with identification information of the program.

According to another aspect of the present invention, there is provided an information processing system, including an information processing device, wherein the information processing device includes a determination part configured to compare condition information of a Web page and attribute information of an instrument transmitted from the instrument in response to a request for acquisition of a list of identification information of the Web page transmitted from the instrument, to determine a Web page capable of being processed in the instrument, and a sending part configured to send a list of identification information of a Web page determined as being capable of being processed in the instrument to the instrument.

According to another aspect of the present invention, there is provided an information processing method, including comparing condition information of a Web page and attribute information of an instrument transmitted from the instrument in response to a request for acquisition of a list of identification information of a Web page transmitted from the instrument, to determine whether a Web page is capable of being processed in the instrument, and sending a list of identification information of a Web page determined as being capable of being processed in the instrument to the instrument.

### BRIEF DESCRIPTION OF THE DRAWINGS

FIG. 1 is a diagram illustrating an example of a configuration of an information processing system in an embodiment of the present invention.

FIG. 2 is a diagram illustrating an example of a configuration of hardware of an image formation apparatus in an embodiment of the present invention.

FIG. 3 is a diagram illustrating an example of a configuration of hardware of a portal server device in an embodiment of the present invention.

FIG. 4 is a diagram illustrating an example of a configuration of software of an image formation apparatus in an embodiment of the present invention.

FIG. 5 is a diagram illustrating an example of functional configurations of a Web server device, portal server device, and consistency determination device in an embodiment of the present invention.

FIG. 6 is diagram for illustrating one example of a process for displaying a portal page.

FIG. 7 is a diagram illustrating an example of a configuration of an instrument information memory part.

FIG. 8 is a diagram illustrating an example of a configuration of a Web page list memory part.

FIG. 9 is a diagram illustrating one example of determination result information.

FIG. 10 is a diagram illustrating an example of display of a portal picture.

FIG. 11 is a diagram illustrating an example of display of a selection picture.

FIG. 12 is a flowchart for illustrating one example of a process for determination of consistency.

FIG. 13 is a diagram illustrating an example of a configuration of a condition information memory part.

FIG. 14 is a diagram illustrating a second example of a functional configuration of a Web server device in an embodiment of the present invention.

### DETAILED DESCRIPTION OF THE PREFERRED EMBODIMENTS

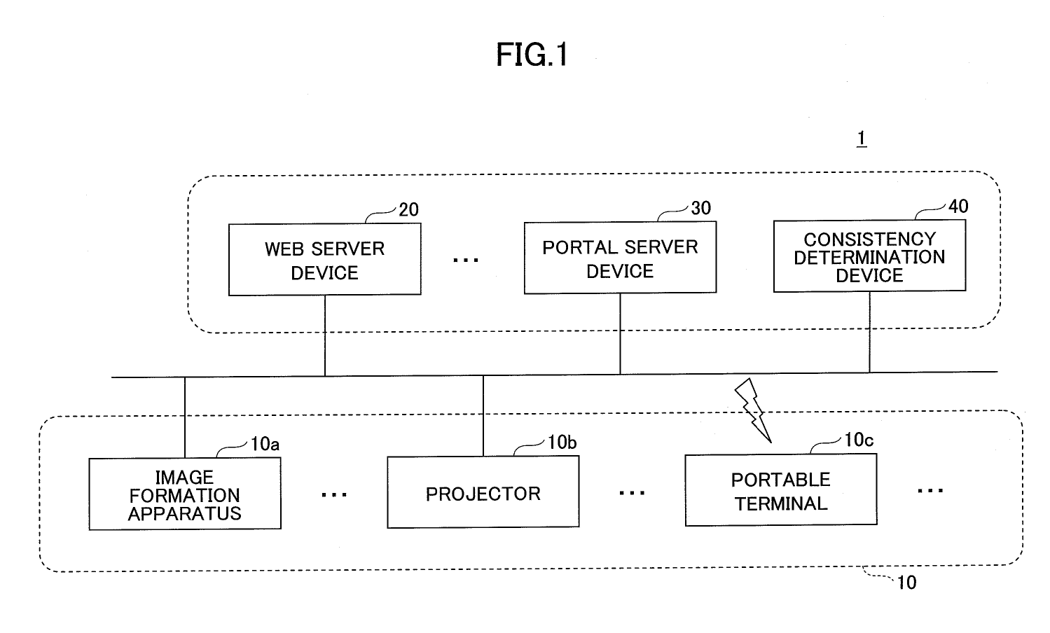

An embodiment of the present invention will be described below based on the drawings. FIG. 1 is a diagram illustrating an example of a configuration of an information processing system in an embodiment of the present invention. In an information processing system 1 in FIG. 1, one or more image formation apparatuses 10a, one or more projectors 10b, one or more portable terminals 10c, etc., are connected to one or more Web server devices 20, portal server devices 30, etc., so as to be capable of communicating therewith, through a network (irrespective of whether it is wired or wireless) such as a Local Area Network (LAN) or the Internet. Furthermore, the portal sever device 30 is connected to a consistency determination device 40 so as to be capable of communicating therewith, through a network such as a LAN or the Internet.

The image formation apparatus 10a as a first example of an instrument 10 is a complex machine for attaining two or more functions among printing, scanning, copying, facsimile (FAX) signal transmitting and receiving, etc., in one housing. However, an instrument having one of the functions as one unit may be used as the image forming apparatus 10a. In the present embodiment, each image formation apparatus 10a includes a Web browser as a program for executing display of a Web page on an operation panel (operation panel 15 as described below), etc. Extension of a function of a Web browser for the image formation apparatus 10a is provided. Hence, a Web browser provided with extension of a function thereof to adapt to a specific function of the instrument 10 will be referred to as an “instrument browser” below.

The projector 10b as a second example of the instrument 10 is an instrument 10 for projecting an image. The projector 10b may also have, for example, an instrument browser as a program for executing display of a Web page on an operation panel included in the projector 10b, etc.

The portable terminal 10c as a third example of the instrument 10 is a portable information processing terminal such as a potable phone, a smart phone, a tablet terminal, a notebook Personal Computer (PC), a Personal Digital Assistance (PDA), etc. The portable terminal 10c may also have, for example, an instrument browser as a program for executing display of a Web page on a display part included in the portable terminal, etc.

Additionally, the image formation apparatus 10a, the projector 10b, and the portable terminal 10c may not be distinguished but may be collectively referred to simply as an “instrument 10”.

Functions of instrument browsers included in the image formation apparatus 10a, the projector 10b, and the portable terminal 10c, are not necessarily identical. For example, scripts capable of being interpreted and executed by respective instrument browsers may be different. Specifically, an instrument browser included in the image formation apparatus 10a is capable of controlling processing with respect to a script indicating a command for executing image formation processing such as printing, scanning, FAX signal transmitting, etc. An instrument browser included on the projector 10b is capable of controlling processing with respect to a script indicating a command for projecting an image. An instrument browser included in the portable terminal 10c is capable of controlling processing with respect to a script indicating, for example, a command for signal transmission of a phone, a command for imaging by a digital camera, etc.

Thus, an instrument browser of each instrument 10 is capable of interpreting a script indicating a command for executing a specific function of the corresponding instrument 10. A script indicating a command for executing a specific function of the instrument 10 is not included in a so-called standard script (for example, Java (registered trademark) script, etc.). Hence, in particular, a script indicating a command for executing a specific function of the instrument 10 is referred to as an “extended script”.

The Web server device 20 is a computer for providing a Web page. In the present embodiment, a Web page refers to picture information defined based on a predetermined format such as Hyper Text Markup Language (HTML) or data for defining or describing, for example, a script indicating a command for processing to be issued in response to an operation on a picture displayed based on such picture information, etc. Each Web page is assigned a unique Uniform Resource Locator (URL). When a HyperText Transfer Protocol (HTTP) request addressed to a URL is transmitted from the instrument 10, such an HTTP request is transferred to the Web server device 20 for providing a Web page corresponding to such a URL.

The portal server device 30 is a computer for providing a portal site for a group of Web pages provided by the Web server device 20. Specifically, the portal server device 30 provides each instrument 10 with a Web page (which will be referred to as a “portal page” below) for displaying a picture of a list of Web pages provided by the Web server device 20 (which will be referred to as a “portal picture” below). It is possible for a user to select a desired Web page with reference to such a portal page.

The consistency determination device 40 is a computer for executing determination of presence or absence of consistency between a Web page displayed on a portal page and the instrument 10 that requests the portal server device 30 to provide a portal page, etc. Consistency between the instrument 10 and a Web page refers to such an instrument 10 being capable of processing such a Web page. More specifically, consistency between the instrument 10 and a Web page refers to such an instrument 10 being capable of executing an extended script included in such a Web page.

Additionally, although the Web server device 20, the portal server device 30, and the consistency determination device 40 are conveniently separate computers in the present embodiment, functions of two or more of the devices may be attained by one computer.

Alternatively, each of the Web server device 20, the portal server device 30, and the consistency determination device 40 may be composed of a plurality of separate computers.

Furthermore, the Web server device 20, the portal server device 30, and the consistency determination device 40 may compose a part or all of a cloud environment for providing an application or service that may be utilized by a plurality of users.

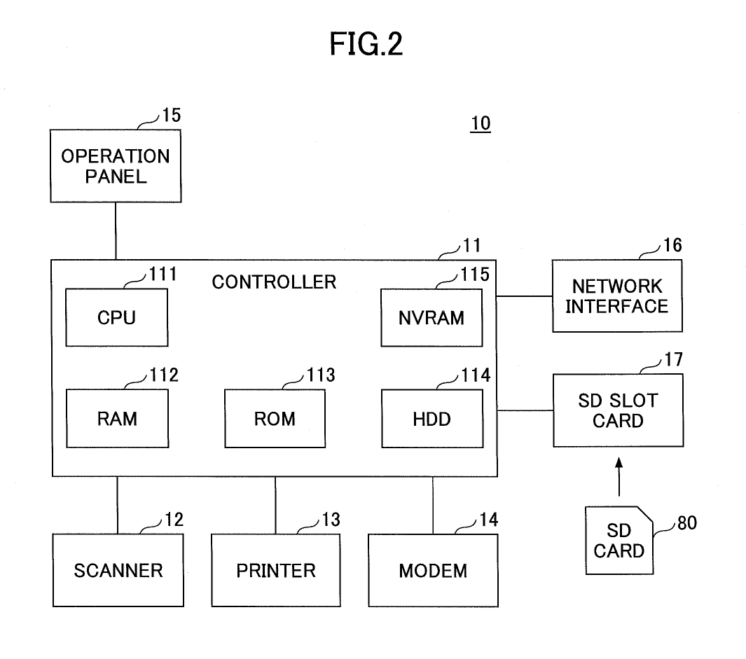

FIG. 2 is a diagram illustrating an example of a configuration of hardware of an image formation apparatus in an embodiment of the present invention. In FIG. 2, an image formation apparatus 10a includes hardware such as a controller 11, a scanner 12, a printer 13, a modem 14, an operation panel 15, a network interface 16, and an SD card slot 17.

The controller 11 includes a Central Processing Unit (CPU) 111, a Random Access Memory (RAM) 112, a Read Only Memory (ROM) 113, a Hard Disk Drive (HDD) 114, a Non-Volatile Random Access Memory (NVRAM) 115, etc. In the ROM 113, a variety of programs, data to be utilized by a program, etc., are stored. The RAM 112 is used as a memory area for loading a program, a working area for a loaded program, etc. The CPU 111 processes a program loaded in the RAM 112, thereby attaining a variety of functions. In the HDD 114, a program, a variety of data to be utilized by a program, etc. are stored. In the NVRAM 115, a variety of setting information, etc., are stored.

The scanner 12 is hardware (an image reading part) for reading image data from an original document. The printer 13 is hardware (a printing part) to print printing data on a printing paper sheet. The modem 14 is hardware for connecting to a telephone line and is used for executing transmission or receipt of image data through FAX communication. The operation panel 15 is hardware that includes an input part such as a button for conducting reception of an input from a user, a display part such as a liquid crystal panel, etc. The liquid crystal panel may have a touch panel function. In such a case, such a liquid crystal panel also has a function of an input part. The network interface 16 is hardware for connecting to a network (irrespective of whether it is wired or wireless) such as a LAN. The SD card 17 is utilized for reading a program stored in the SD card 80. That is, a program stored in the SD card 80 as well as a program stored in the ROM 113 may be loaded on and executed in the RAM 112 in the image formation apparatus 10a. Additionally, the SD card 80 may be replaced by another recording medium (for example, a Compact Disk—Read Only Memory (CD-ROM), a Universal Serial Bus (USB) memory, etc.). That is, the kind of a recording medium corresponding to the position of the SD card 80 is not limited to a predetermined one. In such a case, it is sufficient that the SD card slot 117 is replaced by hardware corresponding to the kind of a recording medium.

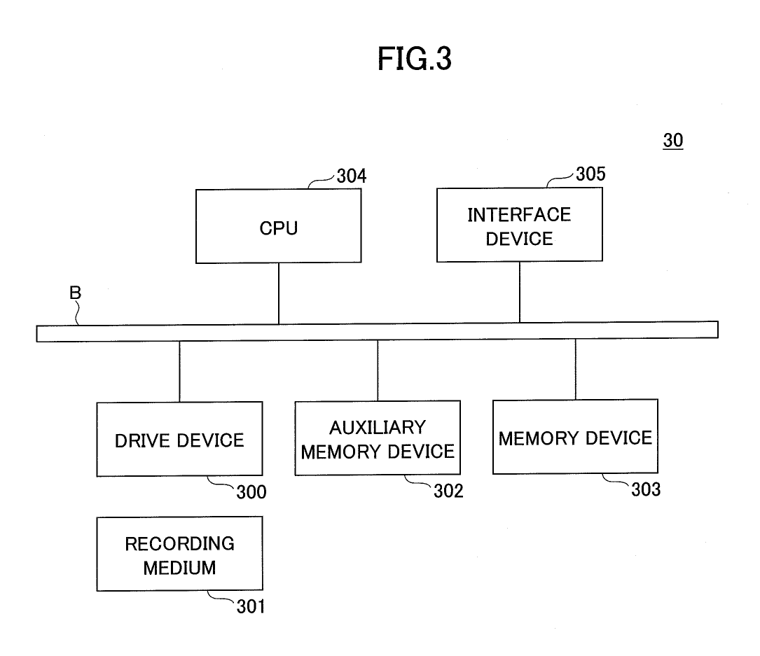

FIG. 3 is a diagram illustrating an example of a configuration of hardware of a portal server device in an embodiment of the present invention. A portal server device 30 in FIG. 3 includes a drive device 300, an auxiliary memory device 302, a memory device 303, a CPU 304, an interface device 305, etc., which are mutually connected by a bus B.

A program for attaining processing on the portal server device 30 is provided by a recording medium 301 such as a CD-ROM. As the recording medium 301 with a program stored therein is set at the drive device 300, such a program is installed from the recording medium 301 through the drive device 300 into the auxiliary memory device 302. However, installation of a program is not necessarily conducted via the recording medium 301 and may be conduced by downloading from another computer through a network. The auxiliary memory device 302 stores an installed program and stores a necessary file, data, etc.

The memory device 303 reads and stores therein a program from the auxiliary memory device 302 when an instruction for starting such a program is provided. The CPU 304 executes a function for the portal server device 30 in accordance with a program stored in the memory device 303. The interface device 305 is used as an interface for connecting to a network.

Additionally, the Web server device 20 and the consistency determination device 40 also include hardware similar to that of FIG. 3.

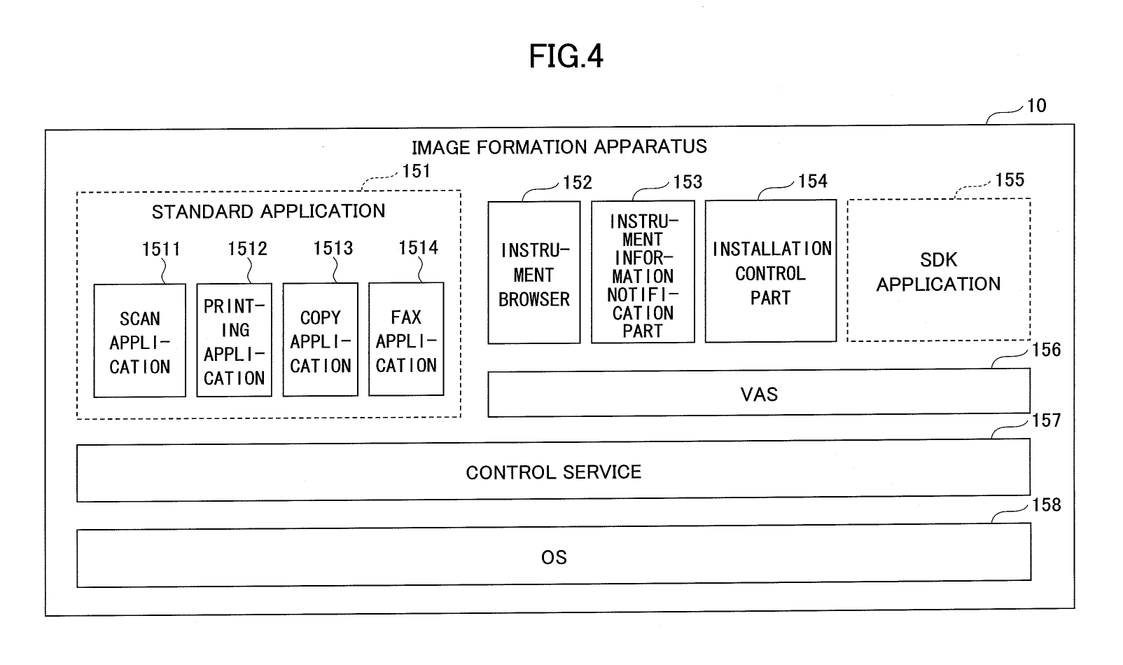

FIG. 4 is a diagram illustrating an example of a configuration of software of an image formation apparatus in an embodiment of the present invention. In FIG. 4, an image formation apparatus 10a includes a standard application 151, an instrument browser 152, an instrument information notification part 153, an installation control part 154, a Software Development Kit (SDK) application 155, a Virtual Application Service (VAS) 156, a control service 157, an Operating System (OS) 158, etc.

The OS 158 is a so-called Operating System (OS). Each kind of software for the image formation apparatus 10a operates as a process or thread on the OS 158.

The standard application 151 is a set of application programs that are normally packaged (preliminarily at a factory) in the image formation apparatus 10a. In the same figure, a scan application 1511, a printing application 1512, a copy application 1513, and a FAX application 1514 are illustrated. The scan application 1511 executes a scan job. The printing application 1512 executes a printing job. The copy application 1513 executed a copy job. The FAX application 1514 executes a FAX signal transmitting job or signal receiving job.

The control service 157 is a program module group for providing a function for controlling a variety of hardware resources, etc., to a host application, etc., or executing a fundamental function of the image formation apparatus 10a, etc.

The VAS 156 conducts wrapping of an interface of the control service 157 and absorbs a difference of such an interface of the control service 157 as caused by an upgrade thereof. Hence, compatibility of a program operating on the VAS 156 is ensured between versions of the control service 157.

The SDK application 155 is an application developed to conduct extension of a function of the image formation apparatus 10a as a plug-in for the image formation apparatus 10a. That is, the image formation apparatus 10a includes an API disclosed for development of the SDK application 155. An API provided by the VAS 156 is one example of the disclosed API. Additionally, the SDK application is represented by a broken block (or rectangle) in FIG. 4. Such a matter indicates that a plurality of the SDK applications 155 may be installed in one image formation apparatus 10a.

The instrument browser 152 is an instrument browser as described above. The instrument information notification part 153 transmits attribute information of the image formation apparatus 10a (which will be referred to as “instrument information” below) to the portal server device 30 at a predetermined timing. For example, the instrument information notification part 153 transmits instrument information to the portal server device 30 whenever the image formation apparatus 10a is started.

The installation control part 154 controls installation processing of a variety of programs for the image formation apparatus 10a. Such a variety of programs includes the SDK application 155, installation of a program module composing the control service 157, etc.

Additionally, each instrument 10 other than the image formation apparatus 10a may also have a software structure as illustrated in FIG. 4. For the standard application 151, it is sufficient that an application corresponding to a specific function of the corresponding instrument 10 is packaged therein.

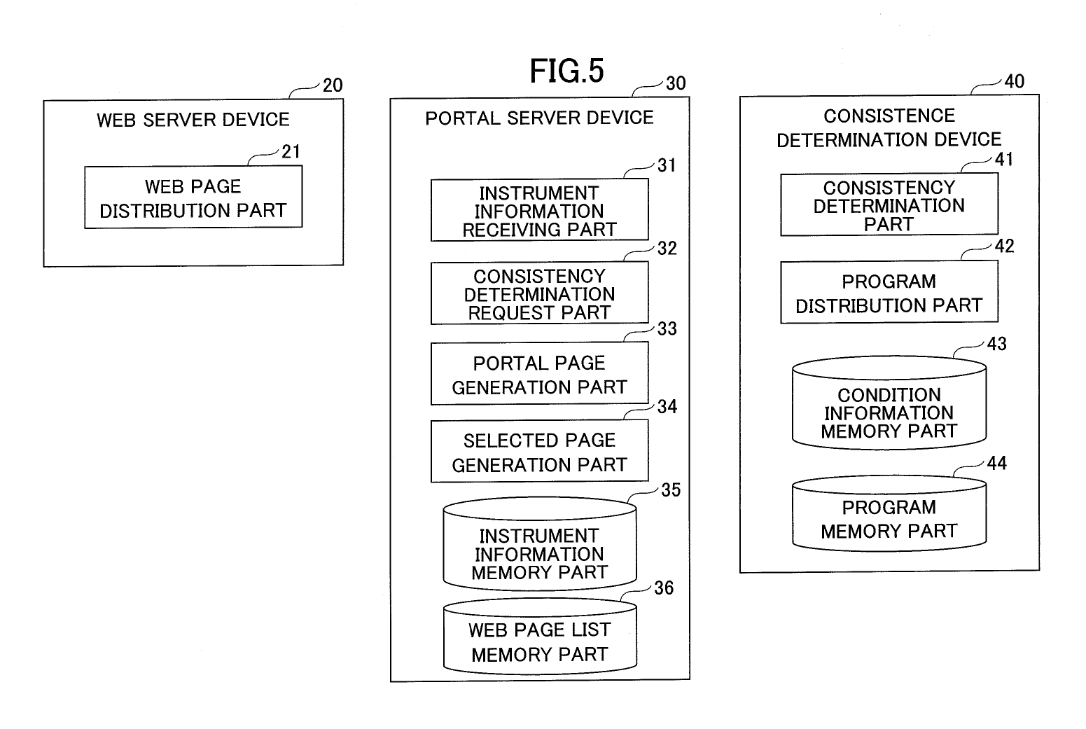

FIG. 5 is a diagram illustrating an example of functional configurations of a Web server device, a portal server device, and a consistency determination device in an embodiment of the present invention.

In FIG. 5, a Web server device 20 includes a Web page distribution part 21. The Web page distribution part 21 sends a response (HTTP response) including a Web page corresponding to an URL specified by a request (HTTP request) for acquisition of a Web page to a source of transmission of such an HTTP request. A Web page included in such a response may be preliminarily generated and stored in a memory device or may be generated in response to a request for acquisition of a Web page.

Additionally, the Web page distribution part 21 is provided by a process which, for example, a program such as a Web application as installed in the Web server device 20 causes a CPU of the Web server device 20 to execute.

A portal server device 30 includes an instrument information receiving part 31, a consistency determination request part 32, a portal page generation part 33, a selected page generation part 34, etc. Each of such parts is provided by a process in which a program installed in the portal server device 30 causes a CPU 304 to execute. Furthermore, the portal server device 30 utilizes an instrument information memory part 35, a Web page list memory part 36, etc. Each of such memory parts is capable of being provided by using an auxiliary memory device 302 or the portal server device 30 and a memory device connected thereto through a network, etc.

The Web page list memory part 36 stores Web page list information for a selection candidate on a portal page. Such list information may be set for each user. Additionally, Web page list information refers to a list of identification information of Web pages, etc.

The instrument information receiving part 31 receives instrument information transmitted from the image formation apparatus 10a. The instrument information receiving part 31 stores received instrument information in the instrument information memory part 35.

The consistency determination request part 32 requests a consistency determination device 40 to conduct determination of presence or absence of consistency between the image formation apparatus 10a requesting acquisition of a portal page and each Web page whose identification information, etc., is stored in the Web page list memory part 36. In such a request for determination of presence or absence of consistency, instrument information of the image formation apparatus 10a requesting acquisition of a portal page and identification information of each Web page that is stored in the Web page list memory part 36 are specified.

The portal page generation part 33 generates a portal page. The portal page generation part 33 determines a Web page as a selection candidate on a portal page, among Web pages whose identification information, etc., is registered in the Web page list memory part 36, based on a result of determination conducted by the consistency determination device 40.

The selected page generation part 34 generates a Web page (which will be referred to as a “selected page” below) on which a picture for making a user select agreement or disagreement with installation of a program is displayed (which will be referred to as a “selection picture” below). Additionally, installation also means updating of an existing program as well as installation of a new program, in the present embodiment.

The consistency determination device 40 includes a consistency determination part 41 and a program distribution part 42. Each of such parts is provided by a process in which a program installed in the consistency determination device 40 causes a CPU of the consistency determination device 40 to execute. The consistency determination device 40 also utilizes a condition information memory part 43 and a program memory part 44. It is possible to provide each of such memory parts by using, for example, an auxiliary memory device included in the consistency determination device 40 or a memory device connected to the consistency determination device 40 through a network.

The consistency determination part 41 determines presence or absence of consistency between the image formation apparatus 10a that is a source of a request for acquisition of a portal page and each Web page in response to a request of the consistency determination request part 32 in the portal server device 30. For determination of presence or absence of consistency, the condition information memory part 43 is utilized. The consistency determination part 41 sends a response including a result of determination to the consistency determination request part 32.

The condition information memory part 43 stores information indicating a condition necessary for processing a Web page for each of such Web pages.

The program distribution part 42 sends a program for a request for acquisition in response to a request for acquisition of a program (or a request for downloading). Such a program is acquired by the program memory part 44. The program memory part 44 stores a substantive program in association with identification information of such a program (program ID) and version information thereof.

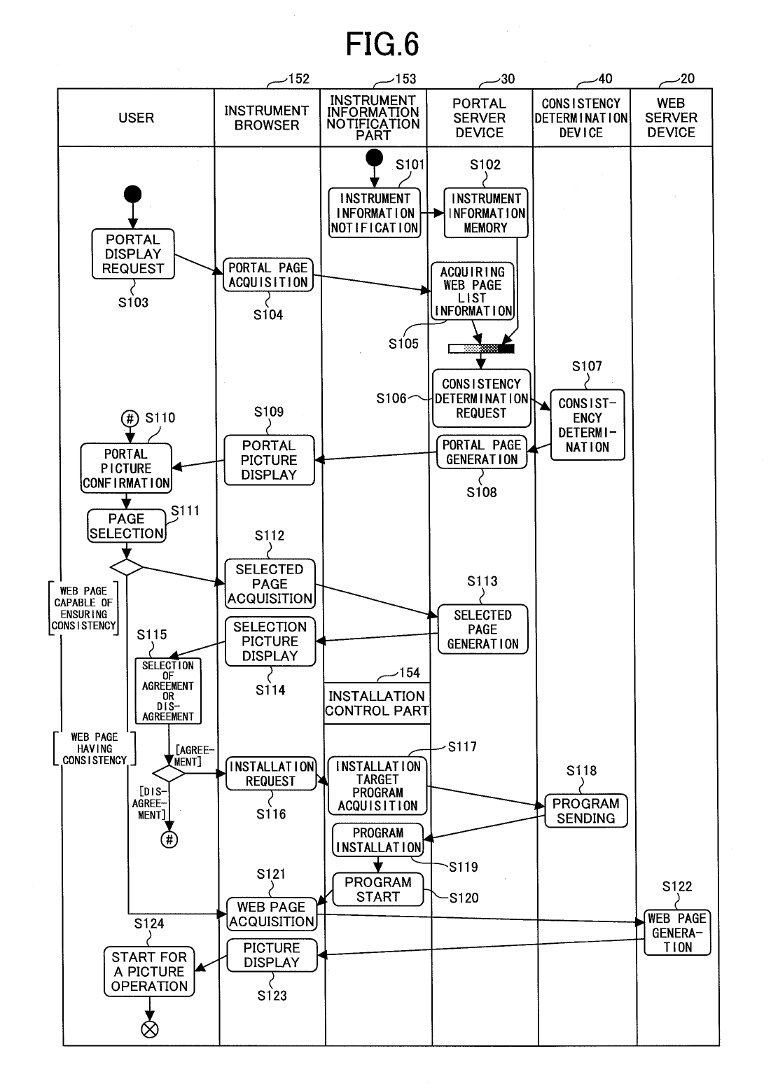

A process to be executed in the information processing system 1 will be described below. FIG. 6 is a diagram for illustrating one example of a process for displaying a portal page. FIG. 6 illustrates such a process in the form of an activity diagram.

The instrument information notification part 153 of the image formation apparatus 10a transmits instrument information of the image information apparatus 10a to the portal server device 30 at a predetermined timing such as a time of starting of the image formation apparatus 10a (S101). The instrument information receiving part 31 of the portal server device 30 stores such instrument information in the instrument information memory part 35 in response to receipt of the instrument information (S102).

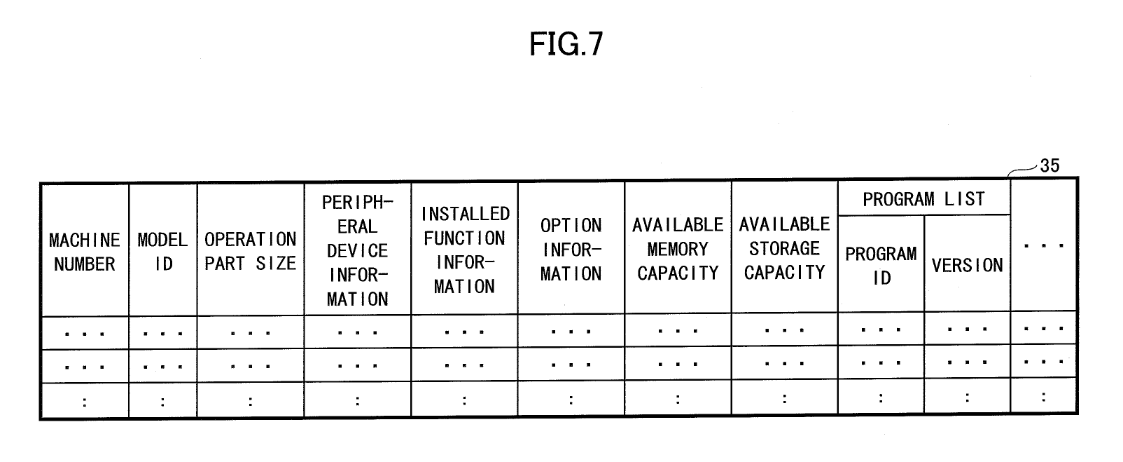

FIG. 7 is a diagram illustrating an example of a configuration of an instrument information memory part. In FIG. 7, an instrument information memory part 35 stores a machine number, a model ID, an operation part size, peripheral device information, installed function information, option information, an available memory capacity, an available storage capacity, a program list, etc., for each image formation apparatus 10a. That is, such items are included in instrument information in the present embodiment. Furthermore, instrument information including such items is transmitted at step S101.

The machine number is identification information for each machine (individual) of each image formation apparatus 10a. The model ID is identification information of a model of the image formation apparatus 10a. The operation part size is a size of a liquid crystal panel in the operation panel 15. The peripheral device information is information indicating a status of connection of a peripheral device such as an integrated circuit (IC) card reader or a coin rack. The installed function information is information indicating a status of installation of a function specific to the image formation apparatus 10a such as a scanning function, a printing function, a FAX function, or a copying function. The option information is information indicating a status of setting of hardware capable of being set as an option, such as a finisher. The available memory capacity is an available capacity of the RAM 112. The available storage capacity is an available capacity of a non-volatile memory device such as the NVRAM 115 or the HDD 114. The program list is a list of program identification information (program ID) and version information installed in the image formation apparatus 10a. A program as described herein refers to, for example, a program module capable of being additionally installed into the SDK application 155 or the control service 157, etc.

Then, as an instruction for display of a portal picture is inputted by a user through the operation panel 15 (S103), the instrument browser 152 transmits an HTTP request indicating a request for acquisition of a portal page to the portal server device 30 (S104). For such a request for acquisition, a machine number of the image formation apparatus 10a is specified. Alternatively, for such a request for acquisition, instrument information of the image formation apparatus 10a may be specified. In such a case, none of steps S101 and S102 may be executed.

As a request for acquisition of a portal page is received in the portal server device 30, the consistency determination request part 32 acquires Web page list information from the Web page list memory part 36 (S105).

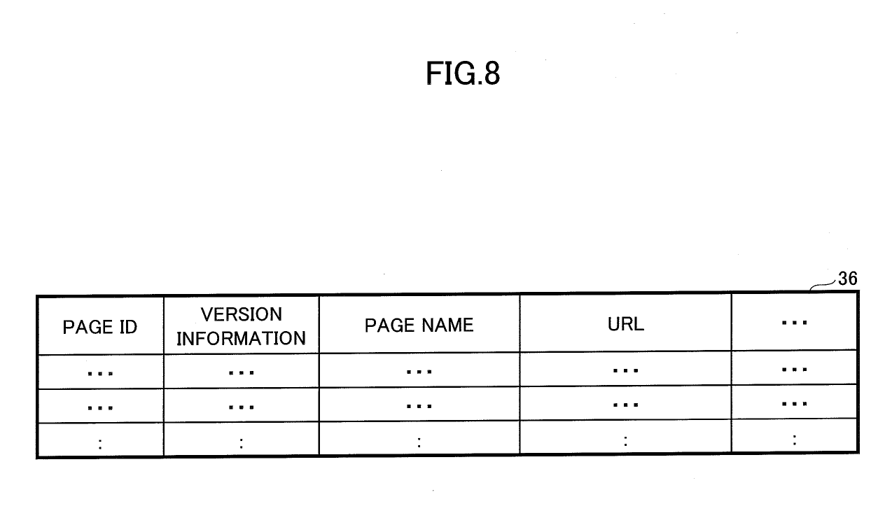

FIG. 8 is a diagram illustrating an example of a configuration of a Web page list memory part. In FIG. 8, the Web page list memory part 36 stores a page ID, version information, a page name, a URL, etc., for each Web page. The page ID is an ID of each Web page. The version information is information for identifying a version of a Web page with an identical page ID. The page name is a name of a Web page. For example, a title of a Web page may be utilized as a page name. The URL is a URL for a Web page. Additionally, a URL may be used as a page ID.

At step S105, at least a page ID and version information of each Web page are acquired from the Web page list memory part 36.

Then, the consistency determination request part 32 specifies instrument information of the image formation apparatus 10a (which will be referred to as a “target instrument 10a” below) as a source of a request for acquisition of a portal page and Web page list information and transmits a request for determination of consistency to the consistency determination device 40 (S106). Instrument information of the target instrument 10a is acquired from the instrument information memory part 35 based on a machine number specified in a request for acquisition of a portal page. However, when instrument information is specified in the request for acquisition of a portal page, such instrument information may be transmitted to the consistency determination device 40.

As a request for determination of consistency is received in the consistency determination device 40, the consistency determination part 41 determines presence or absence of consistency between the target instrument 10a and each Web page included in Web page list information based on instrument information and Web page list information specified in such a request for determination and information stored in the condition information memory part 43 (S107). The details of step S107 will be described below. The consistency determination part 41 sends a response including information indicating a result of determination (which will be referred to as “determination result information” below) to the consistency determination request part 32.

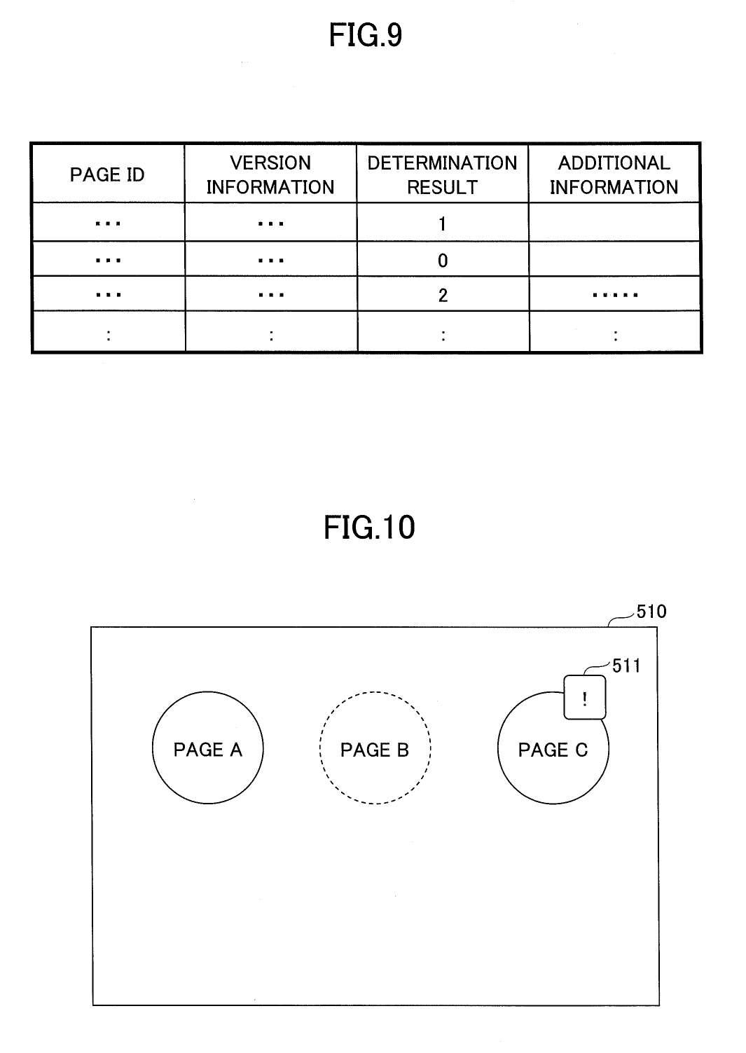

FIG. 9 is a diagram illustrating one example of determination result information. In FIG. 9, determination result information includes a page ID, version information, a determination result, additional information, etc., for each Web page.

The page ID and the version information are a page ID and version information, respectively, of a Web page that is a target for determination of consistency. The determination result is a result of a determination for such a Web page. “0” indicates that consistency is absent. That is, a Web page with a determination result of “0” indicates that it may be impossible for the target instrument 10a to conduct normal processing. “1” indicates that consistency is present. “2” indicates that installation of a certain program is needed for ensuring consistency. In other words, “2” indicates that consistency may be ensured by installing a certain program.

The additional information is recorded with respect to a Web page with a determination result of “2”. The additional information includes, for example, program ID and version information of a program that should be installed for ensuring consistency, etc.

Additionally, the determination result information may not include one of a set of a page ID and version information of a Web page with no consistency and a set of a page ID and version information of a Web page with consistency. That is because it is possible for one of information items to specify another Web page.

As determination result information is received in the portal server device 30, the portal page generation part 33 generates a portal page based on such determination result information and information stored in the Web page list memory part 36 (S108). The portal page generation part 33 sends an HTTP response including a generated portal page to the instrument browser 152 of the target instrument 10a.

The instrument browser 152 of the target instrument 10a displays a portal picture on the operation panel 15 based on a definition of a portal page (S109). A user confirms a displayed portal picture (S110).

FIG. 10 is a diagram illustrating an example of display of a portal picture. As illustrated in FIG. 10, an icon for selecting such a Web page as a display target is displayed on a portal picture for each Web page. On each icon, a page name of a corresponding Web page is displayed. However, only an icon corresponding to a Web page having consistency with the target instrument 10a or a Web page capable of ensuring such consistency is selectable. In other words, an icon corresponding to a Web page having no consistency with the target instrument 10a is displayed as grayed-out. That is, the portal page generation part 33 generates a portal page based on determination result information in such a manner that only an icon corresponding to a Web page having consistency with the target instrument 10a or a Web page capable of ensuring such consistency is operable while an icon corresponding to a Web page having no consistency with the target instrument 10a is gray out (inoperable). Being capable of ensuring consistency means that consistency is absent at present but consistency may be ensured by installing a certain program.

In FIG. 10, gray out is expressed by a broken line. Hence, it is not possible for a user to select an icon for “page B”. Furthermore, being capable of ensuring consistency is indicated by adding an icon 511. Hence, due to the icon 511, it is possible for a user to recognize that it is possible to ensure consistency for “page C”.

It is possible for a user to readily identify a Web page available in the target instrument 10a by referring to such a portal picture 510.

Then, an icon corresponding to a Web page that a user desires to utilize is selected via the portal picture 510 (S111). When a selected icon corresponds to a Web page capable of ensuring consistency (when an icon for “page C” is selected in FIG. 10), the instrument browser 152 transmits an HTTP request indicating a request for acquisition of a selected page to the portal server device 30 in accordance with a definition of a portal page. Such a request for acquisition includes program ID and version information of an installation target program, etc. That is, when an icon corresponding to a Web page with determination result of “2” is selected in determination result information, the Web page distribution part 21 generates a portal page so that a request is transmitted for acquisition of a selected page for which program ID and version information of an installation target program are specified.

As a request for acquisition of a selected page is received in the portal server device 30, the selected page generation part 34 generates a selected page (S113). When permission for installation is selected, the selected page generation part 34 generates a selected page so as to call a script indicating a command for installation of a program corresponding to program ID and version information specified in the request for acquisition of a selected page. The selected page generation part 34 sends a response including a generated selected page to the instrument browser 152.

The instrument browser 152 displays a selection picture on the operation panel 15 in accordance with a definition of a received selected page (S114).

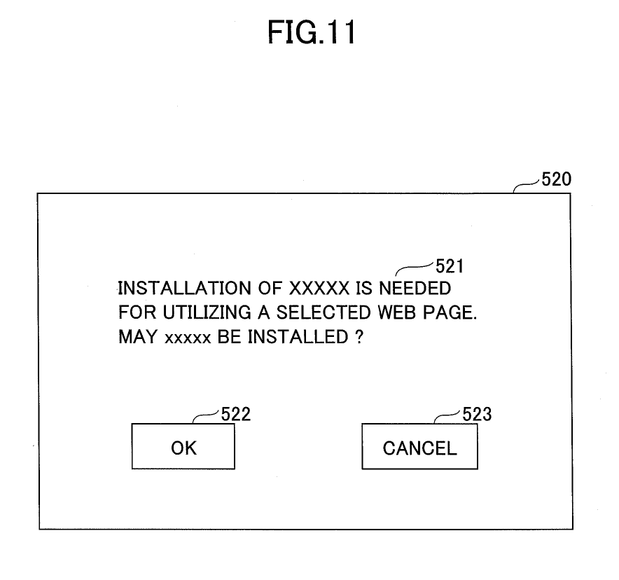

FIG. 11 is a diagram illustrating an example of display of a selection picture. As illustrated in FIG. 11, a selection picture 520 includes a message 521, an OK button 522, a cancel button 523, etc.

The message 521 indicates installation of a program being necessary for utilization of a selected Web page and an inquiry as to agreement or disagreement with installation of such a program. At a portion of “xxxxx” in the message 521, for example, program ID and version information of an installation target program is displayed. When installation of a plurality of programs is needed, program ID and version information of such a plurality of programs may be listed.

A user pushes the cancel button 523 in a case of disagreement with installation. The instrument browser 152 returns to the state of step S110 in response to a push of the cancel button 523. That is, the instrument browser 152 displays the portal picture 510 again.

As a user pushes the OK button 522 so as to agree with installation, the instrument browser 152 specifies program ID and version information of an installation target program in accordance with a definition of a selected page and requests the installation control part 154 to conduct installation of such a program (S116). A request for installation of a program sent to the installation control part 154 is executed by, for example, calling an extended script indicating a command for installation of a program, which is defined in a selected page.

The installation control part 154 specifies program ID and version information specified in a request for installation and transmits a request for acquisition (or a request for downloading) of a program relating to such program ID and version information to the consistency determination device 40 (S117). As a request for acquisition of a program is received in the consistency determination device 40, the program distribution part 42 acquires a program associated with program ID and version information specified in such a request for acquisition from the program memory part 44. The program distribution part 42 sends an acquired program to the installation control part 154 (S118).

As the installation control part 154 receives the sent program, such a program is installed into the target instrument 10a (S119). Then, the installation control part 154 starts a process or thread of such a program (S120). Then, the installation control part 154 sends a response to the request for installation to the instrument browser 152.

Additionally, a computer other than the consistency determination device 40 may be requested to conduct acquisition (or downloading) of a program. For example, a downloading server may be set separately from the consistency determination device 40 and such a downloading server may include the program distribution part 42 and the program memory part 44.

Then, the instrument browser 152 transmits an HTTP request indicating a request for acquisition of a Web page to a URL associated with an icon selected on the portal picture 510 (S121). That is, each icon on a portal page is associated with a URL for a Web page corresponding to such an icon. When a Web page corresponding to a selected icon is a Web page capable of ensuring consistency and steps from S112 are executed, a URL associated with a selected icon is received on a request for acquisition of a selected page and such a selected page. A selected page includes a definition for executing, for example, an extended script indicating a command for installation of a program in response to a push of the OK button 522 and subsequently transmitting a request for acquisition of a Web page to such a URL.

Additionally, when an icon corresponding to a Web page with consistency is selected at step S111, the instrument browser 152 immediately transmits a request for acquisition of a Web page to a URL associated with such an icon (S121).

As a request for acquisition of a Web page is received in the Web server device 20, the Web page distribution part 21, for example, generates a Web page corresponding to a URL specified in such a request for acquisition (S122). However, a preliminarily generated Web page may be acquired. The Web page distribution part 21 sends a generated or acquired Web page to the instrument browser 152 as a source of the request for acquisition.

As the instrument browser 152 of the target instrument 10a receives a sent Web page, a picture indicated by such a web page is displayed on the operation panel 15 (S123). A user starts an operation of such a picture (S124). In response to an operation of such a picture, an extended script included in such a Web page is executed. The consistency determination device 40 has verified that it is possible to execute such an extended script in the target instrument 10a. Furthermore, a program necessary for execution of such an extended script is automatically installed according to need. Hence, it is highly likely for the target instrument 10a to normally execute processing corresponding to an operation on such a picture.

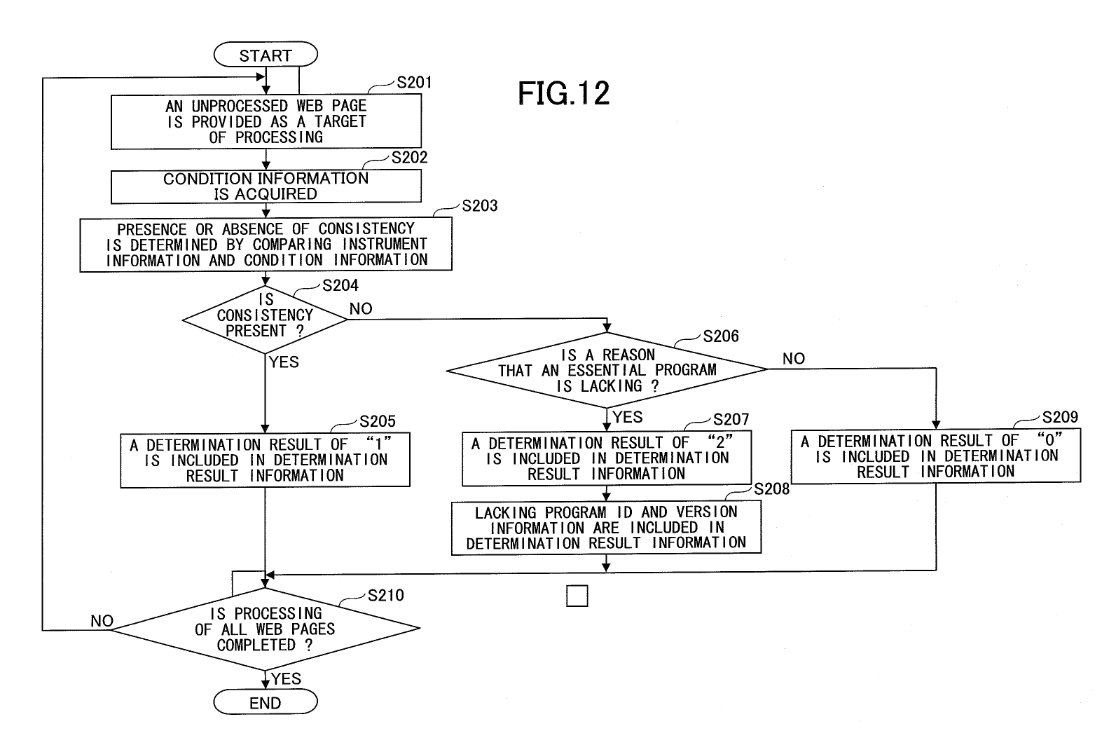

Next, the details of step S107 will be described. FIG. 12 is a flowchart for illustrating one example of a process for determination of consistency.

At step S201, the consistency determination part 41 provides information (a page ID and version information) of one Web page among Web page list information specified in a request for determination of consistency, as a target of processing. Then, the consistency determination part 41 acquires condition information with respect to a page ID and version information of a target of processing from the condition information memory part 43 (S202).

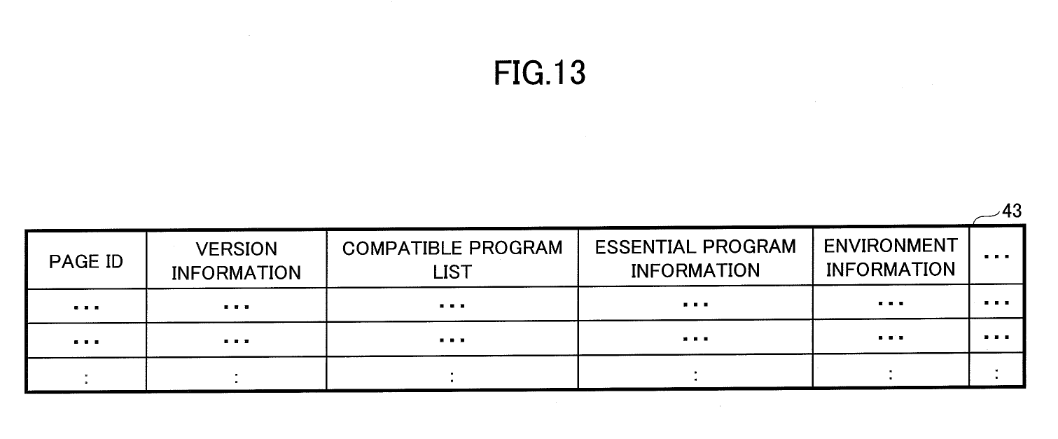

FIG. 13 is a diagram illustrating an example of a configuration of a condition information memory part. As illustrated in FIG. 13, a condition information memory part 43 stores condition information including a compatible program list, an essential program list, environment information, etc., for each Web page identified by a page ID and version information.

The compatible program list is a list of program ID and version information of a program that does not have an exclusionary relationship with such a Web page. A program that does not have an exclusionary relationship with a Web page refers to a program provided in such a manner that a process which such a program causes the image formation apparatus 10a to execute does not influence a process executed by the instrument browser 152 based on such a Web page. In other words, a program that has an exclusionary relationship with a Web page refers to a program provided in such a manner that a process with respect to such a Web page may not normally be conducted by a process which such a program causes the image formation apparatus 10a to execute. A program that is not included in the compatible program list is a program that has an exclusionary relationship with such a Web page. Additionally, a list of programs that have exclusionary relationships with such a Web page (incompatible programs) may be specified in condition information, instead of the compatible program list.

The essential program list is a list of program ID and version information of a program that is essential to be installed in the image formation apparatus 10a in order to process such a Web page normally. For example, program ID and version information of a program to be called when an extended script included in such a Web page is executed are included in the essential program list.

Environment information is information indicating an environment necessary to process such a Web page normally. In the present embodiment, the environment information includes items such as a model ID, an operation part size, peripheral device information, option information, an available memory capacity, and an available storage capacity. The meaning of each of such items is identical to the meaning of an item that composes instrument information and has an identical item name. That is, the model ID is a model ID of a model in which it is possible to process such a Web page normally. The operation part size is a size of a liquid crystal panel on which it is possible to display such a Web page normally. The peripheral device information is information of a peripheral device necessary to process such a Web page normally. Such function information is information of a function necessary to process such a Web page normally. The option information is information of an option necessary to process such a Web page normally. The available memory capacity is an available memory capacity necessary to process such a Web page normally. The available storage capacity is an available storage capacity necessary to process such a Web page normally.

Additionally, the number of a value of each item is not limited to one. For example, a plurality of values may be set as model IDs or operation part sizes.

As described above, the condition information is set as a condition on instrument information. Additionally, the compatible program list and essential program list in the condition information correspond to conditions on a program list in instrument information.

Then, the consistency determination part 41 conducts comparison between instrument information of the target instrument 10a specified in a request for determination of consistency and condition information acquired at step S202 and conducts determination as to presence or absence of consistency of a Web page as a target of processing with the target instrument 10a (S203). Specifically, when all of the following conditions (1)-(8) are satisfied, determination of consistency being present is made:

(1) a model ID in instrument information being included in a model ID in condition information;

(2) combinations of all of program ID and version information included in a program list in instrument information being included in a compatible program list in condition information;

(3) combinations of all of program ID and version information included in an essential program list in condition information being included in a program list in instrument information;

(4) peripheral device information in instrument information satisfying peripheral device information of environment information in condition information;

(5) installed function information in instrument information satisfying installed function information of environment information in condition information;

(6) option information in instrument information satisfying option information of environment information in condition information;

(7) an available memory capacity in instrument information being greater than or equal to an available memory capacity of environment information in condition information; and

(8) an available storage capacity in instrument information being greater than or equal to an available storage capacity of environment information in condition information.

When all of (1)-(8) described above are satisfied (Yes at S204), the consistency determination part 41 includes a determination result of “1” with respect to page ID and version information of a Web page as a target of processing, in determination result information (FIG. 9) (S205).

On the other hand, when one of (1)-(8) described above is not satisfied (No at S204), the consistency determination part 41 determines as to whether only (3) is an unsatisfied condition (S206). That is, determination is made as to whether a reason why consistency is absent is that a program necessary to process a Web page as a target of determination has not been installed in the target instrument 10a.

When only (3) is an unsatisfied condition (Yes at S206), the consistency determination part 41 includes a determination result of “2” with respect to page ID and version information of a Web page as a target of processing in determination result information (FIG. 9) (S207). Then, the consistency determination part 41 includes, in determination result information, a combination that is not included in a program list in instrument information among combinations of program ID and version information included in an essential program in condition information, as additional information with respect to page ID and version information of a Web page as a target of processing (S208). Additionally, such a combination is identified by the consistency determination part 41 at time of determination of the condition of (3).

On the other hand, when not only (3) is an unsatisfied condition (No at S206), the consistency determination part 41 includes a determination result of “0” with respect to page ID and version of a Web page as a target of processing in determination result information (FIG. 9) (S209).

As steps S201-S209 are executed with respect to combinations of all of page ID and version information included in Web page list information specified in a request for determination of consistency (Yes at S210), a process of FIG. 12 is ended.

As described above, according to the present embodiment, a portal page is generated so that an icon of a Web page capable of being processed by the image formation apparatus 10a as a source of a request for acquisition of a portal page is displayed in such a portal picture so as to be distinguished from a Web page that is not capable of being processed. Hence, it is possible to present a Web page list corresponding to the image formation apparatus 10a as a source of a request for acquisition of a portal page to a user.

Furthermore, according to the present embodiment, a Web page capable of being processed by installing a program into the image formation apparatus 10a is also displayed in a portal picture as a selection candidate. When such a Web page is selected, such a program is automatically acquired and installed. Hence, it is possible to readily increase available Web pages.

Additionally, although an illustration has been provided for the image formation apparatus 10a in the present embodiment, the image formation apparatus 10a may be replaced by another instrument 10 such as the projector 10b or the portable terminal 10c to implement the present embodiment. Furthermore, the image formation apparatus 10a may be replaced by an instrument 10 that is not illustrated in the figures, such as a digital camera, to implement the present embodiment.

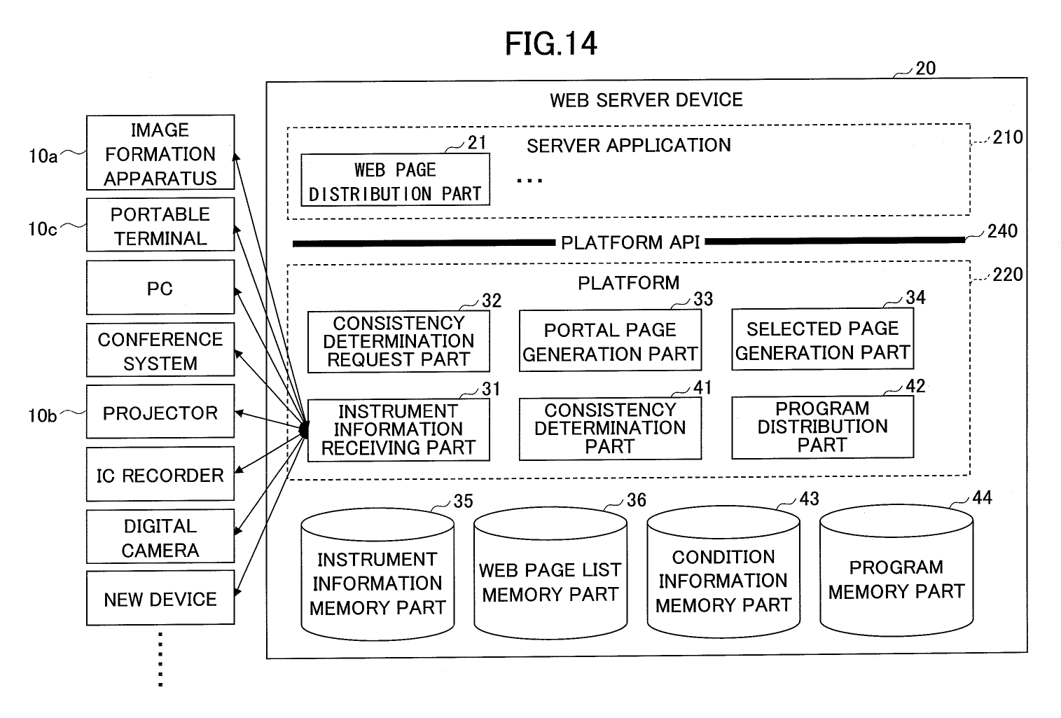

Additionally, when the functions of the portal server device 30 and consistency determination device 40 are packaged in the Web server device 20, the Web server device 20 may have, for example, a functional configuration as illustrated in FIG. 14.

FIG. 14 is a diagram illustrating a second example of a functional configuration of a Web server device in an embodiment of the present invention. In FIG. 14, an identical reference numeral is provided to a part identical to that of FIG. 5 and a description thereof will be omitted.

In FIG. 14, software of a Web server device 20 is separated into layers such as a server application 210 and a platform 220.

The server application 210 is an application program for attaining a service provided by the Web server device 20. Such a service may be attained by a linkage of the server application 210, the image formation apparatus 10, etc. Furthermore, such a service may be a service attained by a linkage with another cloud service such as an on-line storage, etc. In the present embodiment, a Web page distribution part 21 is one example of the server application 210.

The platform 220 includes, for example, function common to a plurality of the server applications 210 or a basic function to be utilized from a plurality of the server applications 210. In the present embodiment, an instrument information receiving part 31, a consistency determination request part 32, a portal page generation part 33, a selected page generation part 34, a consistency determination part 41, a program distribution part 42, etc., are included in the platform 220. The function of each part of the platform 220 has been disclosed to the server application 210 through a platform API 240. In other words, it is possible for the server application 210 to utilize such a function of each part within the scope disclosed by the platform API 240.

Additionally, as illustrated in FIG. 14, a service provided by the Web server device 20 may be executed for, for example, a PC, a conference system, an IC recorder, a digital camera, and other new devices, as well as the image formation apparatus 10a, the projector 10b, and portable terminal 10c.

Furthermore, a classification format of each software part and each memory part as illustrated in FIG. 14 is one example, and in order to implement the present embodiment, it is not necessary that each software part and each memory part of the Web server 20 are classified in a hierarchy as illustrated in FIG. 14. That is, as long as an instrument is capable of linking with the server application 210, a hierarchical relationship of software and a memory part in the Web server 20, etc., is not limited to a specific one.

Additionally, the portal server device 30 and the consistency determination device 40 are merely examples of an information processing device in the present embodiment. That is, an information processing device may be attained by one computer or may be attained by a plurality of computers. The consistency determination part 41 is one example of a determination part. The portal page generation part 33 is one example of a sending part. The instrument browser 152 is one example of a display control part. The instrument information notification part 153 is one example of a transmission part. The installation control part 154 is one example of an acquisition part.

### APPENDIX <An Illustrative Embodiment(s) of an Information Processing Device, an Instrument, an Information Processing System, an Information Processing Method, and an Information Processing Program>

At least one illustrative embodiment of the present invention may relate to at least one of an information processing device, an instrument, an information processing system, an information processing method, and an information processing program.

An object of at least one illustrative embodiment of the present invention may be to provide at least one of an information processing device, an instrument, an information processing system, an information processing method, and an information processing program that are capable of presenting a list of Web pages corresponding to an instrument.

At least one illustrative embodiment of the present invention may be an information processing device including a condition information memory part for storing, for each Web page, identification information of such a Web page and condition information for indicating a condition necessary for processing such a Web page, a determination part for comparing, in response to a request for acquisition of a list of identification information of the Web page that is transmitted from an instrument, the condition information of such a Web page and attribute information of the instrument that is transmitted from the instrument, for each Web page, to determine a Web page capable of being processed in the instrument, and a sending part for sending, to the instrument, a list of identification information of a Web page determined by the determination part as being capable of being processed in the instrument.

Illustrative Embodiment (1) is an information processing device including a condition information memory part for storing, for each Web page, identification information of such a Web page and condition information for indicating a condition necessary for processing such a Web page, a determination part for comparing, in response to a request for acquisition of a list of identification information of the Web page that is transmitted from an instrument, the condition information of such a Web page and attribute information of the instrument that is transmitted from the instrument, for each Web page, to determine a Web page capable of being processed in the instrument, and a sending part for sending, to the instrument, a list of identification information of a Web page determined by the determination part as being capable of being processed in the instrument.

Illustrative Embodiment (2) is the information processing device as described in Illustrative Embodiment (1), wherein the condition information includes identification information of a program necessary for processing a Web page, wherein the attribute information includes identification information of a program installed in the instrument, wherein the determination part specifies identification information of a program that is not included in the attribute information in identification information of a program included in the condition information, for each Web page, and wherein the sending part also causes identification information of a Web page for which identification information of a program has been specified by the determination part to be included in the list while associating with such identification information of a program.

Illustrative Embodiment (3) is an instrument including a transmission part for transmitting attribute information of such an instrument to the information processing device as described in Illustrative Embodiment (2), a display control part for transmitting a request for acquisition of a list of identification information of a Web page and displaying the list sent in response to the request for acquisition on a display device, and an acquisition part for acquiring such a program through a network when identification information of a program is associated with identification information of a Web page selected in the list.

Illustrative Embodiment (4) is an information processing system including an instrument connected thereto through a network and an information processing device, wherein the information processing device includes a condition information memory part for storing, for each Web page, identification information of such a Web page and condition information for indicating a condition necessary for processing such a Web page, a determination part for comparing, in response to a request for acquisition of a list of identification information of the Web page that is transmitted from the instrument, the condition information of such a Web page and attribute information of the instrument that is transmitted from the instrument, for each Web page, to determine a Web page capable of being processed in the instrument, and a sending part for sending, to the instrument, a list of identification information of a Web page determined by the determination part as being capable of being processed in the instrument.

Illustrative Embodiment (5) is the information processing system as described in Illustrative Embodiment (4), wherein the condition information includes identification information of a program necessary for processing a Web page, wherein the attribute information includes identification information of a program installed in the instrument, wherein the determination part specifies identification information of a program that is not included in the attribute information in identification information of a program included in the condition information, for each Web page, and wherein the sending part also causes identification information of a Web page for which identification information of a program has been specified by the determination part to be included in the list while associating with such identification information of a program.

Illustrative Embodiment (6) is an information processing method wherein an information processing device executes a determination step for comparing, in response to a request for acquisition of a list of identification information of a Web page that is transmitted from the instrument, condition information for indicating a condition necessary for processing such a Web page stored by a condition information memory part for each Web page and attribute information of the instrument that is transmitted from the instrument, for each Web page, to determine a Web page capable of being processed in the instrument, and a sending step for sending, to the instrument, a list of identification information of a Web page determined in the determination step as being capable of being processed in the instrument.

Illustrative Embodiment (7) is the information processing method as described in Illustrative Embodiment (6), wherein the condition information includes identification information of a program necessary for processing a Web page, wherein the attribute information includes identification information of a program installed in the instrument, wherein the determination step specifies identification information of a program that is not included in the attribute information in identification information of a program included in the condition information, for each Web page, and wherein the sending step also causes identification information of a Web page for which identification information of a program has been specified in the determination step to be included in the list while associating with such identification information of a program.

Illustrative Embodiment (8) is an information processing method wherein an instrument executes a transmission step for transmitting attribute information of such an instrument to the information processing device as described in Illustrative Embodiment (2), a display control step for transmitting a request for acquisition of a list of identification information of a Web page and displaying the list sent in response to the request for acquisition on a display device, and an acquisition step for acquiring such a program through a network when identification information of a program is associated with identification information of a Web page selected in the list.

Illustrative Embodiment (9) is an information processing method in an information processing system including an instrument connected thereto through a network and an information processing device, wherein the information processing device executes a determination step for comparing, in response to a request for acquisition of a list of identification information of a Web page that is transmitted from the instrument, condition information for indicating a condition necessary for processing such a Web page stored by a condition information memory part for each Web page and attribute information of the instrument that is transmitted from the instrument, for each Web page, to determine a Web page capable of being processed in the instrument, and a sending step for sending, to the instrument, a list of identification information of a Web page determined in the determination step as being capable of being processed in the instrument.

Illustrative Embodiment (10) is the information processing method as described in Illustrative Embodiment (9), wherein the condition information includes identification information of a program necessary for processing a Web page, wherein the attribute information includes identification information of a program installed in the instrument, wherein the determination step specifies identification information of a program that is not included in the attribute information in identification information of a program included in the condition information, for each Web page, and wherein the sending step also causes identification information of a Web page for which identification information of a program has been specified in the determination step to be included in the list while associating with such identification information of a program.

Illustrative Embodiment (11) is an information processing program causing an information processing device to execute a determination step for comparing, in response to a request for acquisition of a list of identification information of a Web page that is transmitted from the instrument, condition information for indicating a condition necessary for processing such a Web page stored by a condition information memory part for each Web page and attribute information of the instrument that is transmitted from the instrument, for each Web page, to determine a Web page capable of being processed in the instrument, and a sending step for sending, to the instrument, a list of identification information of a Web page determined in the determination step as being capable of being processed in the instrument.

Illustrative Embodiment (12) is an information processing program causing an instrument to execute a transmission step for transmitting attribute information of such an instrument to the information processing device as described in Illustrative Embodiment (2), a display control step for transmitting a request for acquisition of a list of identification information of a Web page and displaying the list sent in response to the request for acquisition on a display device, and an acquisition step for acquiring such a program through a network when identification information of a program is associated with identification information of a Web page selected in the list.

According to at least one illustrative embodiment of the present invention, it may be possible to present a list of Web pages corresponding to an instrument.

Although the illustrative embodiments and specific examples of the present invention have been described with reference to the accompanying drawings, the present invention is not limited to any of the illustrative embodiments and specific examples and the illustrative embodiments and specific examples may be altered, modified, or combined without departing from the scope of the present invention.

The present application claims the benefit of priority based on Japanese Patent Application No. 2012-032623 filed on Feb. 17, 2012 and Japanese Patent Application No. 2012-237515 filed on Oct. 29, 2012, the entire contents of which are hereby incorporated by reference herein.

What is claimed is:

1. An instrument comprising:
a display part;
a transmission part configured to transmit attribute information of the instrument to an information processing device;
a display control part configured to transmit a request for acquisition of a list of identification information of a Web page to the information processing device and display the list sent from the information processing device in response to the request for acquisition on the display part; and
an acquisition part configured to acquire a program through a network when identification information of a Web page selected in the list is associated with identification information of the program.

2. The instrument as claimed in claim 1, wherein the attribute information includes identification information of a program installed in the instrument.

3. The instrument as claimed in claim 1, wherein the Web page is displayed on the display part based on data received from a response corresponding to the request for acquisition to the information processing device.

4. An information processing system, comprising an information processing device,
wherein the information processing device includes
a determination part configured to compare condition information of a Web page and attribute information of an instrument transmitted from the instrument in response to a request for acquisition of a list of identification information of the Web page transmitted from the instrument, to determine whether a Web page is capable of being processed in the instrument; and
a sending part configured to send a list of identification information of a Web page determined as being capable of being processed in the instrument to the instrument.

5. The information processing system as claimed in claim 4, wherein the instrument is connected to the information processing device through a network.

6. The information processing system as claimed in claim 4, wherein the information processing device further includes a condition information memory part configured to store identification information of the Web page and condition information of the Web page.

7. The information processing system as claimed in claim 4, wherein the condition information is configured to indicate a condition needed to process the Web page.

8. The information processing system as claimed in claim 4, wherein
the condition information includes identification information of a program needed to process a Web page;
the attribute information includes identification information of a program installed in the instrument;
the determination part is configured to specify identification information of a program not included in the attribute information in identification information of a program included in the condition information; and
the sending part is configured to, at least, cause identification information of a Web page having the specified identification information of the program to be associated with the identification information of the program and to be included in the list.

9. An information processing method, comprising:
comparing condition information of a Web page and attribute information of an instrument transmitted from the instrument in response to a request for acquisition of a list of identification information of a Web page transmitted from the instrument, to determine whether a Web page is capable of being processed in the instrument; and
sending a list of identification information of a Web page determined as being capable of being processed in the instrument to the instrument.

10. The information processing method as claimed in claim 9, wherein the condition information is configured to indicate a condition needed to process the Web page.

11. The information processing method as claimed in claim 9, wherein
the condition information includes identification information of a program needed to process a Web page; and
the attribute information includes identification information of a program installed in the instrument,
the information processing method further comprises:
specifying identification information of a program not included in the attribute information in identification information of a program included in the condition information; and
causing identification information of a Web page having the specified identification information of the program to be associated with the identification information of the program and to be included in the list.

12. The information processing method as claimed in claim 9, wherein the Web page is displayed based on data received from a response corresponding to the request for acquisition.
